(19) United States
(12) Patent Application Publication
(10) Pub. No.: US 2008/0273706 A1
(43) Pub. Date: Nov. 6, 2008

(54) System and Method for Controlled Access Key Management

(75) Inventor: Landon Curt Noll, Sunnyvale, CA (US)

Correspondence Address: FISH & RICHARDSON P.C., PO BOX 1022, MINNEAPOLIS, MN, 55440-1022, US

(73) Assignee: NeoScale Systems, Milpitas, CA (US)

(21) Appl. No.: 11/744,477

(22) Filed: May 4, 2007

(51) Int. Cl. H04L 9/14

(52) U.S. Cl. 380/279

(57) ABSTRACT

Embodiments of the present invention provide controlled access to key management servers using store and forward protocols. A computer-implemented method for providing controlled key management includes generating a request indicative of a key management function. The request is received at the first of a number of intermediate parties capable of relaying the request toward a key management server. The key management function is performed subsequent to receiving the request from the last of the intermediate parties which is authorized to provide the request to the key management server. A response to the request is then generated.

### BACKGROUND OF THE INVENTION

The present invention relates to computer systems. More specifically, the present invention relates to techniques for providing controlled access to key management servers.

In general, a key manager or key management server acts as a secure key vault to store and provide access to one or more keys. A key is a handle on some type of digital asset, which may be encrypted. In general, the key allows a user or computer process to access a digital asset that has been encrypted. Accordingly, it is important to protect and secure keys, while allowing access to the keys as the key manager generally provides more services than just encrypting and decrypting a digital asset, but more importantly provides services to label or manage the key stored in a vault.

FIG. 1 is a simplified diagram of a system 100 for providing key management services in the prior art. In this example, system 100 includes a remote user 110, a communications network 120, a firewall 130, a communications network 140, and a key server 150.

Typically, remote user 110 requests one or more keys from the key server 150 to obtain access to encrypted objects. Remote user 110 may also perform other operations using key server 150, such as creating new keys or destroying old keys. Key server 150 receives requests from the remote user 110, processes the requests, and sends responses to the remote user 110.

In order to access key server 150, remote user 110 typically creates some type of secure tunnel, for example, using TLS, SSL, or another secure means, by which remote user 110 is authenticated to access key server 150. Furthermore, this secure connection is typically a direct connection between remote user 110 and key server 150.

However, some problems exists when remote user 110 is required to access key server 150 in which remote user 110 is physically separated from key server 150, for example in this situation by firewall 130. Firewall 130 is typically configured to provide mitigated access between communications network 120 and communications network 140. In order to establish the direct connection required between remote user 110 and key server 150, one or more holes or ports must be opened on firewall 130. Firewall 130 then accepts connections from remote user 110, and forwards the connections to key server 150 via communications network 140.

Additionally, if other external users or devices wish to access key server 150, firewall 130 must be configured to accept these connections, and for these connections from the other external users or devices to key server 150. In some industries and scenarios, these connections may only be required once, or for a very short period of time.

Thus, to maintain adequate security, an administrator of firewall 130 must be sure to close any holes or ports opened in firewall 130 when the connections are no longer required. This is because for each port opened on firewall 130, a potential security risk is created. If too many ports are holes are opened on firewall 130, the effectiveness and usefulness of having a firewall becomes diminished.

Accordingly, what is desired are improved methods and apparatus for solving the problems discussed above, while reducing the drawbacks discussed above.

### BRIEF SUMMARY OF THE INVENTION

The present invention relates to techniques for providing controlled access to key management servers. In short, embodiments of the present invention provide controlled access to key management servers using store and forward protocols. By designating one or more hosts or intermediate parties configured and authorized to accept connections or requests from clients addressed to a key management server, the one or more hosts or intermediate can deliver requests indicative of key management functions to a protected key management server. Accordingly, rather than opening access to the key management server for each device, network, etc., that needs access to key management services, communication may be performed through a number of intermediate parties (i.e., one or more) that act as gatekeepers.

Thus, a number of intermediate parties, or even only the last of a number of intermediate parties, are required to have privileges to access a protected key management server. Accordingly, embodiments of the present invention may employ existing communications services to provide mitigated access to key management servers, such as e-mail or Internet messaging, that may already include mechanisms for security and authentication, and that further provide scalability for large numbers of users.

In various embodiments, a computer-implemented method for providing controlled key management includes generating a request indicative of a key management function. The request is received at the first of a number of intermediate parties capable of relaying the request toward a key management server. The key management function is performed subsequent to receiving the request from the last of the intermediate parties which is authorized to provide the request to the key management server. A response is then generated to the request.

In some embodiments, receiving the request at the first of a number of intermediate parties capable of relaying the request toward a key management server includes receiving the request at the first of the number of intermediate parties using a store and forward protocol. Receiving the request at the first of a number of intermediate parties capable of relaying the request toward a key management server may include receiving the request at an e-mail server. The number of intermediate parties may be one, such that receiving the request at the first of a number of intermediate parties capable of relaying the request toward a key management server may include receiving the request at the last of the number of intermediate parties.

In various embodiments, the response to the request is received at the first of a number of intermediate parties capable of relaying the response to a client. The last of the number of intermediate parties may be configured to deliver the response to the client. The key management function may include at least one of a create operation, a store operation, a retrieve operation, a find operation, a disable operation, a destroy operation, and a modify operation.

In some embodiments, the request may be encrypted. The request may also be digitally signed. The request may then be authenticated in response to the digital signature, and may be decrypted based on a positive determination that the request is authentic. The response may also be encrypted, and digitally signed. The response may be authenticated in response to the digital signature, and decrypted based on a positive determination that the request is authentic.

In one embodiment, a computer program product is stored on a computer readable medium for providing controlled key management. The computer program product includes code for generating a request indicative of a key management function, code for receiving the request at the first of a number of intermediate parties capable of relaying the request toward a key management server, code for performing the key management function subsequent to receiving the request from the last of the intermediate parties which is authorized to provide the request to the key management server, and code for generating a response to the request.

In various embodiments, a system for providing controlled key management includes a number of intermediate parties and a key management server. The first of the number of intermediate parties may be configured to receive a request indicative of a key management function from a client. The last of the number of intermediate parties may be authorized to provide the request to one or more key management servers. The key management server may be configured to receive the request from the last of the number of intermediate parties, perform the key management function, and generate a response to the request.

In still further embodiments, a system for secured key management includes a key management server and a first server. The first server is communicatively positioned between the key management server and a client. The first server is configured to receive a request addressed to the key management server from the client, the request indicative of a key management function, deliver the request to the key management server if the first server is authorized to deliver a request from a client to the key management server, and relay the request to a second server communicatively positioned between the key management server and the client if the first server is not configured to access the key management server.

The first server may receive a response to the request addressed to the client, deliver the response to the client if the first server is configured to access the client, and relay the response to a third server if the first server is not configured to access the client.

In various embodiments, a system for providing controlled key management includes a processor and a memory. The memory is coupled to the processor and configured to store a plurality of code modules which when executed by the processor cause the processor to receive a request addressed to a key management server from a client, the request indicative of a key management function, deliver the request to the key management server if permitted to deliver requests from clients to the key management server, and relay the request to a first host communicatively positioned between the key management server and the client if not permitted to access the key management server.

The processor may receive a response to the request addressed to the client, deliver the response to the client if capable of accessing the client, and relay the response to a second host communicatively positioned between the key management server and the client if not capable of accessing the client.

A further understanding of the nature and the advantages of the inventions disclosed herein may be realized by reference of the remaining portions of the specification and the attached drawings.

### BRIEF DESCRIPTION OF THE DRAWINGS

In order to more fully understand the present invention, reference is made to the accompanying drawings. Understanding that these drawings are not to be considered limitations in the scope of the invention, the presently described embodiments and the presently understood best mode of the invention are described with additional detail through use of the accompanying drawings.

FIG. 1 is a simplified diagram of a system for providing key management services in the prior art;

FIG. 2 is a block diagram of a system for providing controlled access to a key management server in one embodiment according to the present invention;

FIGS. 3A and 3B are a simplified flowchart of a method for providing controlled access to key management server in one embodiment according to the present invention;

FIG. 4 is a block diagram of a system for providing controlled access to a key management server in one embodiment according to the present invention;

FIG. 5 is a message sequence chart illustrating key management access in the system of FIG. 4 in one embodiment according to the present invention;

FIG. 6 is a block diagram of a system for providing controlled access to a key management server in one embodiment according to the present invention;

FIGS. 7A, 7B, and 7C are a message sequence chart illustrating key management access in the system of FIG. 6 in one embodiment according to the present invention; and

FIG. 8 is a simplified block diagram of a computer system that may incorporate embodiments of the present invention.

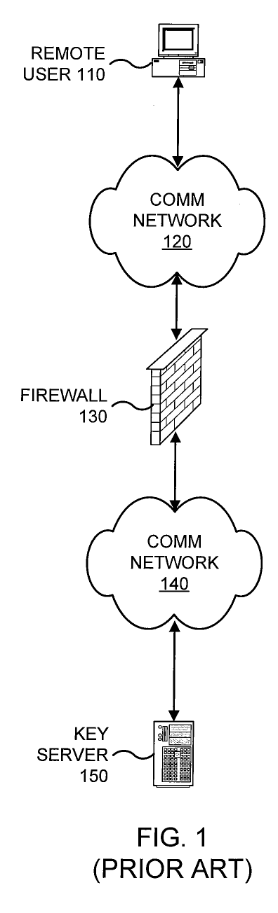

### DETAILED DESCRIPTION OF THE INVENTION

The present invention relates to techniques for providing controlled access to key management servers. In various embodiments, controlled access to a key management server is provided using a store and forward protocol. Some examples of store and forward protocols are file transfer protocol (FTP), simple mail transfer protocol (SMTP), instant or Internet messaging (IM), and the like. A key management server then may be physically or electronically secured while allowing requests for keys and other key management functions to be delivered to the key management server using a number (one or more) of intermediate parties.

The intermediate parties use store and forward protocols to deliver the request to the key management server. Accordingly, a firewall or other network access control mechanism may be configured to allow connections only from those intermediate parties authorized to deliver the request to the key management server.

Thus, a number of intermediate parties, or even only the last of a number of intermediate parties, are required to have privileges to access a key management server. Accordingly, embodiments of the present invention may employ existing communications services, such as e-mail or Internet messaging, that already include mechanisms for security and authentication and that also provides scalability for large numbers of users, to provide mitigated access to key management servers.

Additionally, the key management server may deliver responses to client requests also using store and forward protocols. This allows the functionality of the key management server to scale and provide services to additional unanticipated clients or other devices, while still providing security and control over access to the key management server.

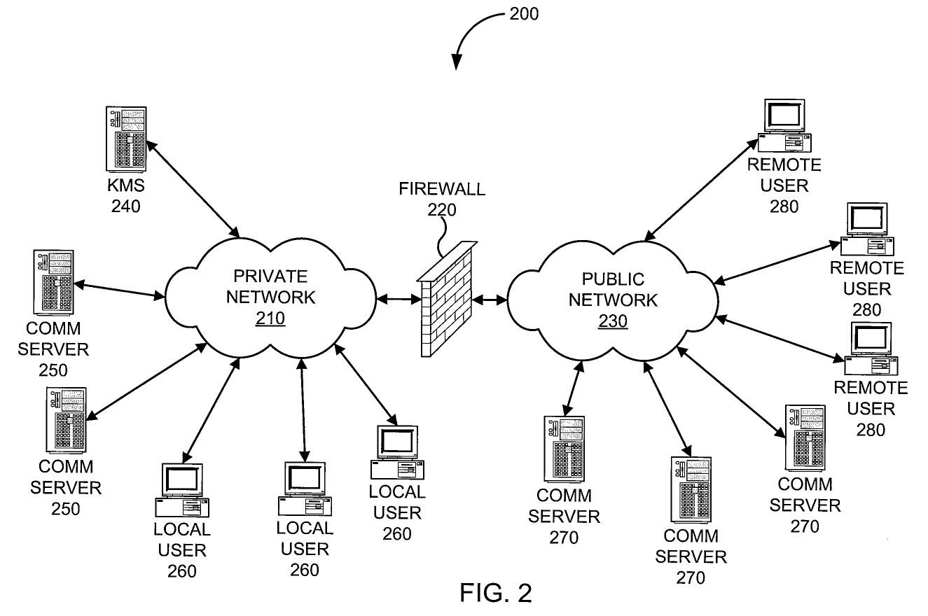

FIG. 2 is a block diagram of a system 200 for providing controlled access to a KMS 240 in one embodiment according to the present invention. In this example, system 200 includes a private network 210, a firewall 220, a public network 230, key management server (KMS) 240, one or more local communications servers 250, one or more local users 260, one or more remote communications servers 270, and one or more remote users 280.

In this example, private network 210 is link via firewall 220 to public communications network 220. Private network 210 is linked to KMS 240, the one or more local communications servers 250, and the one or more local users 260. Public network 230 is linked to remote communications servers 270 and remote users 250.

Private network 210 is any communications network or link for exchanging data. Some examples of private network 210 include local area networks (LANs), wide area networks (WANs), metropolitan area networks (MANs), wireless area networks (WLANs), and the like. Private network 210 may include firewalls, network address translation (NAT) devices, network intrusion detection devices, and the like, to manage access and security.

Firewall 220 includes hardware and/or software elements that permit, deny or proxy data connections between private network 210 and public network 230. In general, firewall 220 controls traffic between computer networks with different zones of trust. Typical, public network 230 (e.g., the Internet) is a zone with little or no trust, and private network 210 (e.g., an internal network) is a zone with high trust. Accordingly, firewall 220 attempts to control interfaces between zones of differing trust levels through the enforcement of a security policy and connectivity model.

Public network 230 is any communications network or link for exchanging data. Some examples of public network 230 include LANs, WANs, MANs, WLANs, hotspots, public leased lines, public networks, the Internet, and the like.

KMS 240 includes hardware and/or software elements that provide one or more key management functions. Some examples of key management functions are key generation, key destruction, key retrieval, key validation, key labeling, and the like. In general, a key is a handle for accessing a digital object or asset. The digital object may be encrypted or otherwise encumbered by a security scheme. One example of KMS 240 is “CryptoStor KeyVault” provided by NeoScale Systems, Inc. of Milpitas, California.

Local communications servers 250 include hardware and/or software elements that provide communications services. Some examples of communications services are e-mail, instant or Internet messaging, file transfer, file storage, short message service, and the like. Local communications servers 250 may use various protocols, such as store and forward protocols, to communicate between other devices. In general, a store and forward protocol is any communication protocol in which a direct connection is not required for communication between one or more hosts. Typically, one or more intermediate parties between a first host and a second host relay communications and/or exchange data between the two hosts.

Local users 260 include hardware and software elements that provide general and specific purpose computing to a user. Some examples include personal computers (PCs), desktops, laptops, handheld devices, mainframes, microcomputers, workstations, thin-clients, and the like.

Remote communications servers 270 include hardware and/or software elements that provide communications services via public network 230. Remote users 260 include hardware and software elements that provide general and specific purpose computing to a user.

In general, firewall 220 provides mitigated access to KMS 240, and local communications servers 250 and local users 260 for connections from public network 230. For example, firewall 220 may accept, reject, drop, deny, and proxy connections from public network 230 to services behind the firewall that are attached to private network 210. Firewall 220 may also perform Network Address Translation (NAT), such as network masquerading, native address translation, or IP-masquerading.

In one example of operation, a local user 250 generates a request indicative of a key management function to obtain access to an encrypted digital asset. Local user 250 then forwards the request via private network 210 to KMS 240. KMS 240 authenticates the request, and generates a response based on performance of the key management function indicated in the request from the local user 260. KMS 240 then forwards a response to local user 250 that may include a key to allow the client to access the encrypted digital asset.

In another example of operation, a local user 250 generates a request indicative of a key management function to obtain access to an encrypted digital asset. Local user 250 then forwards the request via private network 210 to one of local communications servers 260. The particular local communications server 250 may forward the request to KMS 240, or forward the request to another local communications server 250. Eventually, one of local communications server 250 is authorized to provide requests to KMS 240. KMS 240 then authenticates the request, and generates a response based on performance of the key management function indicated in the request from the local user 260.

Typically, if one or more remote users 270 desire to access KMS 240, ports are opened on firewall 220, and forwarded to KMS 240. In one example of operation, system 200 employs one or more intermediate parties (e.g., local and remote communications servers 240 and 260) to convey requests indicative of key management functions to KMS 240 without unnecessarily opening more ports on a firewall. Accordingly, the one or more intermediate parties can store and forward requests indicative of key management functions to the KMS 240 while still maintaining the security of private network 210. Additionally, local and remote communications servers 240 and 260 may be configured to deliver responses from the KMS 240 to local users 260 and remote users 280.

For example, a remote user 260 generates a request indicative of a key management function to obtain access to an encrypted digital asset. Remote user 260 then forwards the request via public network 230 to one of remote communications servers 270. The particular remote communications server 270 may forward the request to firewall 220, or forward the request to another remote communications server 250. Eventually, one of remote communications server 250 is authorized to provide requests to firewall 220. At firewall 220, one or more of local communications servers 250 may be configured to receive requests from remote communications servers 270.

As discussed above, the particular local communications server 250 may forward the request to KMS 240, or forward the request to another local communications server 250. Eventually, one of local communications server 250 is authorized to provide requests to KMS 240. KMS 240 then authenticates the request, and generates a response based on performance of the key management function indicated in the request from the remote user 280.

In some embodiments, KMS240 responds directly to local users 260 or remote users 270. In various embodiments, KMS 240 responds to local users 260 or remote users 270 using a number of intermediate parties (e.g., local communications servers 250 and remote communications servers 270). KMS 240 may response using the same store and forward protocol in which a request was received. KMS 240 may also response using a different protocol that that used to transit the request.

In various embodiments, system 200 provides a drop box using local communications servers 240 and remote communications servers 260 in which local users 260 or remote users 280 can generate a request, which may be digitally signed and encrypted, and placed the request in the drop box via one or more intermediate parties. At a plurality of times, system 200 checks the drop box to determine whether any requests have been deposited, and retrieves the requests, and forwards the request to KMS 240. The drop box may be provided by an FTP server in which the drop box is right only and cannot be read from by unauthorized devices. The drop box may also be provided by secure file copy protocols (SCP).

In various embodiments, system 200 enables existing services that provide store and forward protocol capabilities, such as e-mail to be leveraged in combination with the KMS 240. Typically, e-mail servers include user, host, and network authentication mechanisms, spyware and virus filtering, and already act as gateways into a corporate or private network (e.g., private network 210). Accordingly, KMS 240 may be provided an e-mail address to which requests may be forwarded. E-mail communications received that are addressed to the e-mail address associated with KMS 240 may be logged, filtered, authenticated, virus scanned and spam checked, further encrypted or tunneled, and the like, before reaching KMS 240.

Thus, system 200 provides controlled access to KMS 240 using store and forward protocols. System 200 enables users both local and remote to have access to key management functions without compromising security of private network 210. System 200 further provides mechanisms that allow unanticipated or additional devices to be added anytime to access KMS 240 in a secure manner.

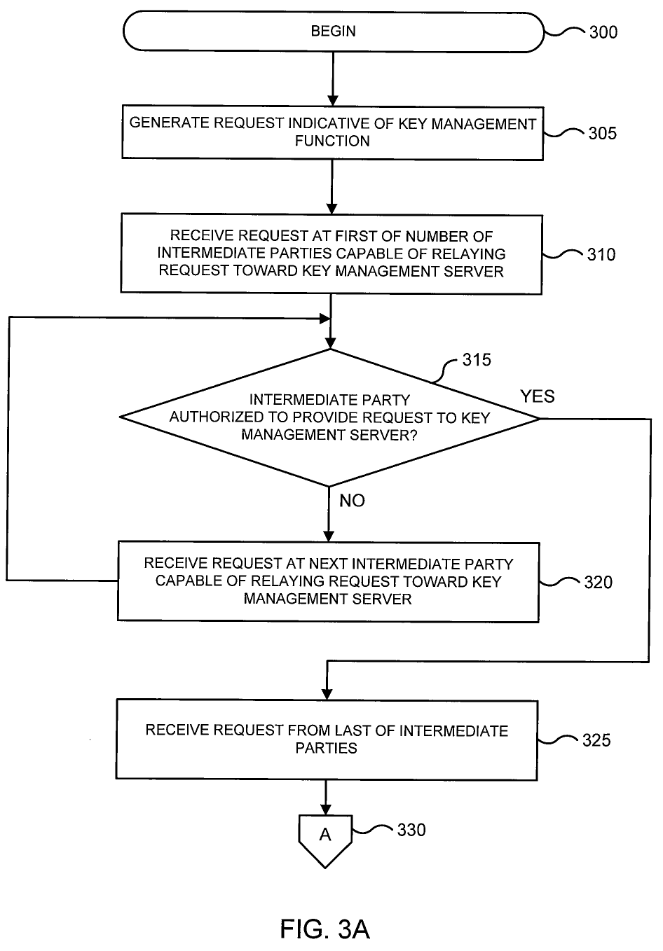

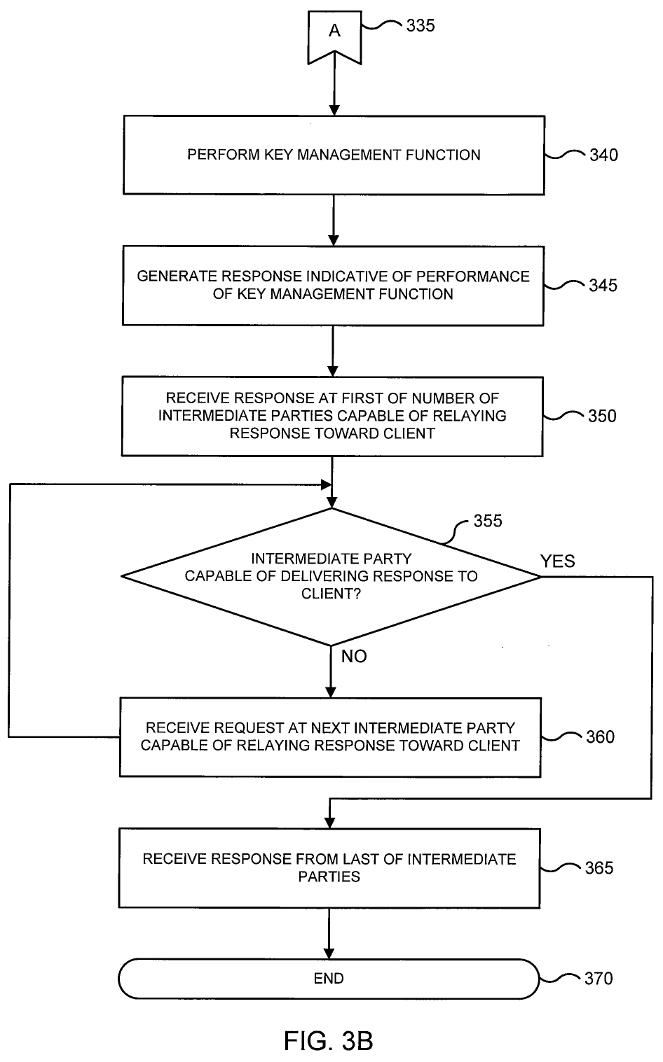

FIGS. 3A and 3B are a simplified flowchart of a method for providing controlled access to KMS 240 in one embodiment according to the present invention. The processing depicted in FIGS. 3A and 3B may be performed by software modules (e.g., instructions or code) executed by a processor of a computer system, by hardware modules of the computer system, or combinations thereof. FIG. 3A begins in step 300.

In step 305, a request is generated indicative of a key management function. A request is any signal, message, instruction, and the like. A key management function is an act, operation, or procedure performed by a key manager. Some examples of key management functions are create operations, delete operations, destroy operations, label operations, retrieve operations, update operations, and the like. In one example, remote user 270 generates a request addressed to KMS 240 to request a key to access an encrypted digital object.

In step 310, the request is received at the first of a number of intermediate parties capable of relaying requests toward a key management server. In general, an intermediate party is any device, host, process, and the like, that receives information from a first host and forwards the information to a second host. In one example, remote user 270 delivers the request to one or more of remote communications servers 270.

In step 315, a determination is made whether an intermediate party (e.g., the first of the number of intermediate parties) is authorized to provide the request to the key management server. Some examples of mechanisms by which the determination may be made may include determinations based upon IP address or network addresses, subnet addresses, Internet service providers, port ranges, MAC or hardware addresses, date and time limitations, and the like.

Based on a negative determination, in step 320, the request is received at the next intermediate party capably of relaying the request toward the key management server. For example, a given remote communications server 270 may forward the request to another remote communications server 270, or to one of local communications servers 250.

Based on a positive determination, in step 325, the request is received at the key management server (e.g., KMS 240) from the last of the intermediate parties. In some embodiments, the last of the number of intermediate parties may also be the first of the number of intermediate parties to which the request was delivered.

FIG. 3A ends in step 330, where processing continues in FIG. 3B. FIG. 3B begins in step 335.

In step 340, the key management function indicated in the request is performed. In step 345, a response is generated indicative of performance of the key management function. In other words, KMS 240 may generate a response including the results of the key management function, such as including the key requested from the remote user 270 to obtain access to the encrypted digital object. In various embodiments, the response may be encrypted and digitally signed by KMS 240.

In step 350, the response is received at the first of a number of intermediate parties capable of delivering the response to the client. For example, KMS 240 may deliver the response to an e-mail server, an instant or Internet messaging server, an FTP server, and the like. In some embodiments, the response may be delivered directly to the client. In step 355, a determination is made whether an intermediate party (e.g., the first of the number of intermediate parties) is capable of delivering the response to the client.

Based on a negative determination, in step 360, the response is received at the next intermediate party capably of relaying the response toward the client. For example, a given local communications server 250 may forward the request to another local communications server 250, or to one of remote communications servers 270.

Based on a positive determination, in step 365, the response is received at the client (e.g., remote user 280) from the last of the intermediate parties. In some embodiments, the last of the number of intermediate parties may also be the first of the number of intermediate parties to which the request was delivered. FIG. 3B ends in step 370.

Accordingly, system 200 provides controlled access to KMS 240 using store and forward protocols. By designating one or more hosts (e.g., local and remote communication servers 250 and 270) that are configured and authorized to accept connections from clients for a key management server, the one or more hosts can be configured to deliver requests indicative of key management functions to the key management server behind the firewall. Accordingly, rather than opening access to the key management server for each device needing access to key management services, devices can communicate through one or more intermediate parties that act as gatekeepers.

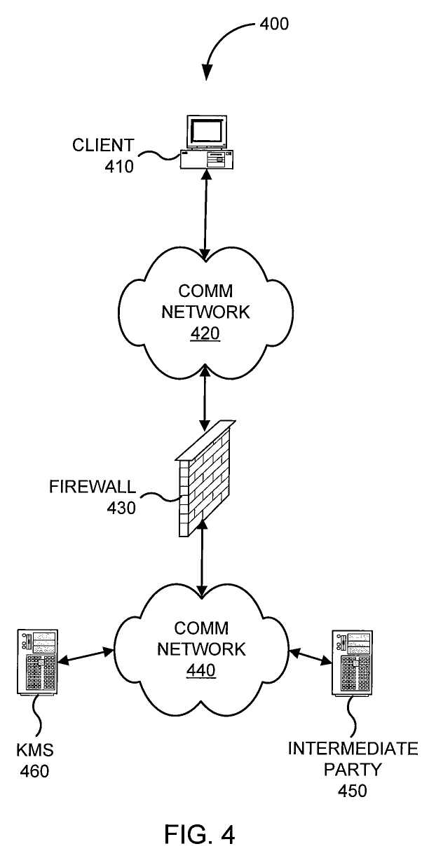

FIG. 4 is a block diagram of a system 400 for providing controlled access to a key management server (KMS) 460 in one embodiment according to the present invention. In this example, system 400 includes a client 410, a communications network 420, a firewall 430, a communications network 440, an intermediate party 450, and KMS 460.

Communications network 420 is linked to client 410 and firewall 430. Communications network 440 is linked to firewall 430, intermediate party 450, and KMS 460.

In general, firewall 430 provides mitigated access to communications network 440 from communications network 420. For example, firewall 430 intercepts connections for FTP communication (e.g., on control port 21), and forwards the connections via communications network 440 to intermediate party 450. In another example, firewall 430 intercepts connections related to Internet relay chat (IRC), instant or Internet messaging, or other messaging services, and forwards the connections via communications network 440 to intermediate party 450.

Intermediate party 450 includes hardware and/or software components for providing communication services. For example, intermediate party 450 may provide simple anonymous file transfers, authenticated file transfers, and or secure encrypted file transfers. Intermediate party 450 may further include user authentication mechanisms and user access policies. While only one intermediate party 450 is shown, any number of intermediate parties may be included in system 400.

KMS 460 includes hardware and/or software elements that provide key management functions. One example of KMS 460 is “CryptoStor KeyVault” provided by NeoScale Systems, Inc. of Milpitas, Calif.

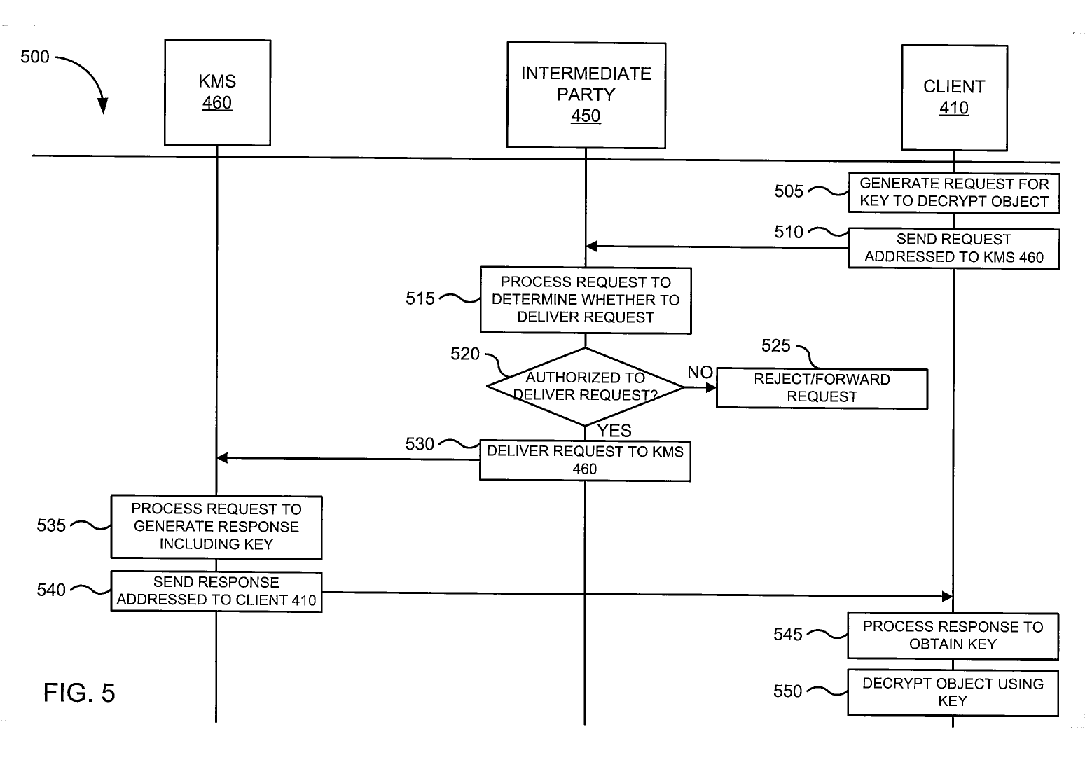

In one example of operation, clients (e.g., client 410) connected to communications network 420 generate and transmit key requests to KMS 460 via communications network 420. Firewall 430 intercepts connections from communications network 420, and accepts, proxies, forwards, or rejects the connections. Connections containing key requests addressed to KMS 460, such as on a particular port or port range, or at a particular e-mail address or other network identifier, are forwarded to intermediate party 450. Intermediate party 450 delivers key requests to KMS 460. For example, intermediate party 450 may push the requests to key management server, or simply wait to be polled key management server to have key requests pulled by key management server. KMS 460 processes key requests and returns the results to the requester. One example of operation of system 400 is described further with respect to FIG. 5.

In various embodiments, key requests addressed to KMS 460 may need to go through one or more intermediate parties 450. An intermediate party that is not authorized to deliver key request or cannot deliver key requests directly to KMS 460 may instead forward key requests to another intermediate party who is authorized or can delivered directly, or who can forward key requests still to another intermediate party. For example, in the case of communicating via e-mail, key requests from a user may have to pass through a corporate gateway, then to an ISP for that company, and then to another ISP (of the network associated with KMS 460), than to an e-mail gateway for the network associated with the KMS 460, and then to KMS 460 itself.

FIG. 5 is a message sequence chart 500 illustrating key management in system 400 in one embodiment according to the present invention. FIG. 5 begins in step 505.

In step 505, client 410 generates a request for a key to decrypt an object. For example, a user of client 410 may be attempting to access an encrypted data file. In some embodiments, client 410 encrypts the request, and digitally signs the encrypted request.

In step 510, client 410 sends the request addressed to KMS 460 over communications network 420 to intermediate party 450. In this example, firewall 430 intercepts connections from communications network 420, and determines whether to accept the connections and forward them to intermediate party 450, or reject the connections. If the connections are accepted, firewall 430 forwards the connections, and thus the request sent by client 410, to intermediate party 450.

In step 515, intermediate party 450 processes the request to determine whether to deliver the request. For example, intermediate party 450 may require that the user of client 410 enter a username and password to deliver the request to intermediate party 450. In some embodiments, intermediate party 450 requires that client 410 be authenticated using a digital signature. Other authentication mechanisms and user security policies may be employed by intermediate party 450. Intermediate party 450 may also scan the request for viruses, spyware, spam, and the like.

In step 520, if intermediate party 450 is not authorized to deliver the request to KMS 460, intermediate party 450 rejects the request in the upload in step 525. For example, intermediate party 450 may accept anonymous incoming connections for other services, such as public file transfers, however anonymous requests placed into directories designated for key management may be rejected. Intermediate party 450 may also accept e-mail designated for KMS 460, however the request must be included in an encrypted e-mail attachment. E-mails not including the encrypted e-mail attachment are dropped by intermediate party 450.

Intermediate party 450 may also forward the request to another host or device capable of relying the request toward a key management server. In various embodiments, intermediate party 450 may determine that it cannot deliver directly to KMS 460. Thus, the request might go through a chain of intermediate parties before delivering to one who is authorized to deliver the request to KMS 460.

If intermediate party 450 is authorized to deliver the request to KMS 460, in step 530, intermediate party 450 delivers the request to KMS 460. For example, a script periodically executed on intermediate party 450 may forward uploaded requests to KMS 460. Alternatively, KMS 460 may periodically poll intermediate party 450 for uploaded requests. Any variety of push and pull mechanisms may be employed to deliver the request to the KMS 460.

In step 535, KMS 460 processes the request to generate a response including the key. KMS 460 may perform one or more key management functions to retrieve, create, or obtain the key requested by client 410. In step 540, KMS 460 sends the response via communications network 440 addressed to client 410.

In some embodiments, KMS 460 may encrypted and digitally sign the response that includes the key. KMS 460 may use encryption programs such as PGP, GPG, and the like, to encrypt the response. Key management server may also use digital signature mechanisms, or electronic signatures, to digitally sign the response.

In step 545, client 410 receives and processes the response to obtain the key. For example, client 410 may verify the digital signature of KMS 460, and decrypt the response to obtain the key. In step 550, client 410 decrypts the object using the key to obtain access to the object. Message sequence chart 500 ends in FIG. 5 at step 550.

Accordingly, firewall 430 in system 400 does not have to provide direct access to KMS 460, while intermediate party 450 may be considered an intermediate party authorized to deliver requests indicative of key management functions to key management server. By mitigating access, KMS 460 may be more securely isolated from attack, while still providing key management to local and remote users.

However, in this example KMS 460 is configured to directly respond to client 410. In various embodiments, KMS 460 may be configured to also use one or more intermediate parties to indirectly forward responses to requests indicative of key management functions. Thus, in various embodiments, KMS 460 is configured to deliver responses to intermediate party 450, which further delivers responses to client 410. In some embodiments, one or more intermediate parties may be used to deliver responses to users. It may be possible that responses may take a different route returning to a user than the route used to deliver key requests to the KMS 460.

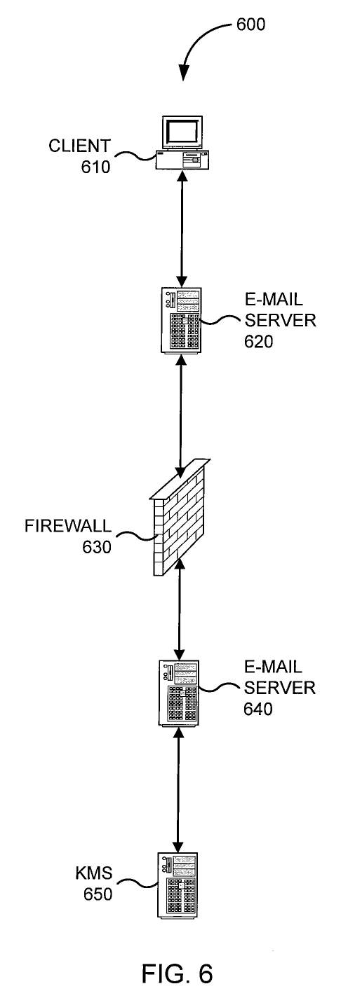

FIG. 6 is a block diagram of a system 600 for providing controlled access to a KMS 650 in one embodiment according to the present invention. System 600 includes a client 610, a remote e-mail server 620, a firewall 630, a local e-mail server 640, and KMS 650. For the sake of simplicity, intermediate public and private communications networks have not been shown.

In this example, remote e-mail server 620 is linked to client 610 and to firewall 630. Local e-mail server 640 is linked to firewall 630 and to KMS 650.

In general, firewall 630 provides mitigated access to local e-mail server 640. For example, firewall 630 intercepts connections related to e-mail communications, and drops or denies all other types of connections. Firewall 630 then forwards connections related to e-mail communications to local e-mail server 640. In this example, connections from remote e-mail server 620 may be forwarded through firewall 630 to local e-mail server 640.

Remote e-mail server 620 and local e-mail server 640 include hardware and or software elements that provide e-mail communications services, such as Microsoft Exchange, IBM Lotus Notes, Linux and Unix messaging systems (e.g., postfix and sendmail), and the like. Remote e-mail server 620 and local e-mail server 620 may be configured to use a variety of protocols such as SMTP, POP3, IMAP, UUCP, rsync, and the like.

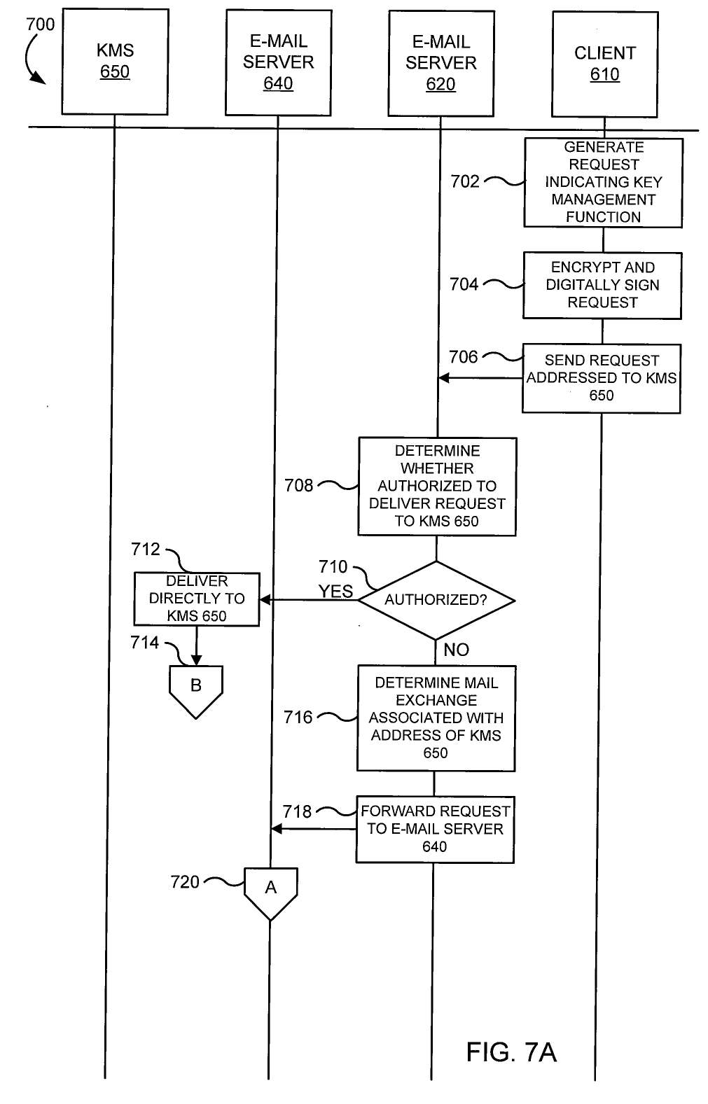

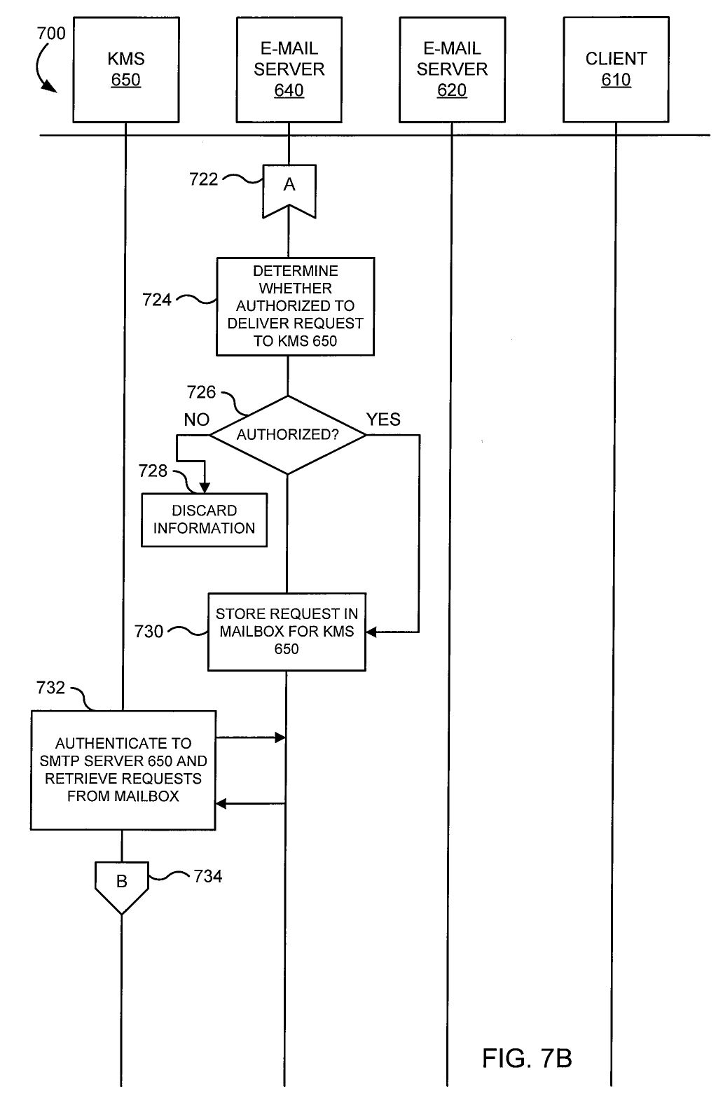

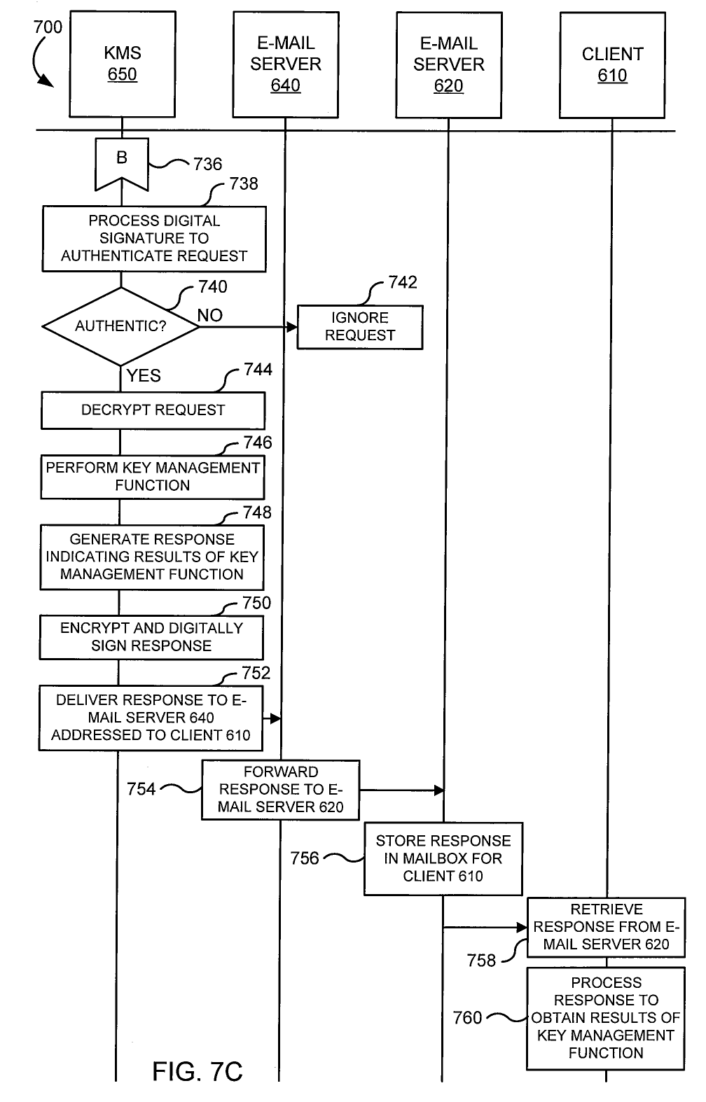

KMS 650 is configured to receive requests using local e-mail server 640, and to forward responses again using local e-mail server 640. Key management server 630 may be provided a mailbox, in which mail sent to an e-mail address assigned to the KMS 650 is deposited into the mailbox associated with the KMS 650. One example of operation of system 600 is described further with respect to FIGS. 7A, 7B, and 7C.

FIG. 7A, 7B, and 7C are a message sequence chart 700 illustrating key management in system 600 in one embodiment according to the present invention. Message sequence chart 700 begins in FIG. 7A in step 702.

In step 702, client 610 generates a request indicative of a key management function. In step 704, client 610 encrypts and digitally signs the request. In step 706, client 610 sends the request to remote e-mail server 620 addressed to KMS 650.

For example, a user of client 610 may attach an encrypted and digitally signed key request to an e-mail. The user then may transmit the e-mail addressed to KMS 650 using a mail client, such as Outlook. In another example, a computer process executing on client 610 using SMTP communicates with e-mail server 620 to deliver an encrypted and digitally signed request that has been automatically generated for the user of client 410 in response to a local operation to access an protected object.

In step 708, remote e-mail server 620 whether it is authorized to deliver the request to KMS 650. For example, remote e-mail server 620 may determine whether it hosts the domain associated with the e-mail address of KMS 650. Based on a positive determination that remote e-mail server 620 is authorized, remote e-mail server 620 would send the request directly to KMS 650 (not shown). However, in this example, remote e-mail server 620 is not authorized to deliver the request to KMS 650 because, in this example, remote e-mail server 620 does not host the domain associated with the e-mail address of KMS 650 or have a direct connection to KMS 650.

In some examples, in step 710, if remote e-mail server 620 is authorized to deliver the request, in step 712, remote e-mail server 620 delivers the request to KMS 650. FIG. 7A then ends processing in step 714, where message sequence chart 700 continues in step 736 of FIG. 7C.

However, in this example, in step 716, remote e-mail server 620 determines one or more e-mail exchanges related to the e-mail address associated with KMS 650. The one or more e-mail exchanges may indicate that local e-mail server 640 is configured to receive e-mail for the KMS 650. In this example, local e-mail server 640 is configured to be the destination indicated by the one or more e-mail exchanges. In step 718, remote e-mail server 620 forwards the encrypted and digitally signed request to local e-mail server 640. FIG. 7A ends in step 720, where message sequence chart 700 continues in step 722 of FIG. 7B.

Referring to FIG. 7B, in this example, firewall 630 intercepts e-mail communications (e.g., from remote e-mail server 620), and forwards the e-mail communications to local e-mail server 640. In step 724, local e-mail server 640 determines whether it is authorized to deliver the request to KMS 650. For example, local e-mail server 640 may determine whether it recognizes the e-mail address used to deliver the request. Local e-mail server 640 may perform other policy-based, host-based, user-based, and network checks to determine whether it is authorized to deliver requests to KMS 650. Local e-mail server 640 may also perform virus scanning, spam filtering, and other checks on the request to determine the validity, authenticity, and the like of the request.

In step 726, if local e-mail server 640 is not authorized to deliver the information to KMS 650, in step 728, local e-mail server 640 discards the request. Local e-mail server 640 may also reject the request, or accept the request and subsequently discard the request without generating an error message.

In step 726, if local e-mail server 640 is authorized to deliver the request to KMS 650, in step 730, local e-mail server 640 stores the request in a mailbox associated with KMS 650. In step 732, at one of a plurality of times, KMS 650 authenticates to local e-mail server 640 and retrieves requests stored in the mailbox associated with KMS 650. FIG. 7B ends in step 734, where message sequence chart 700 continues in step 736 of FIG. 7C.

Referring now to FIG. 7C, in step 738, KMS 650 processes the digital signature associated with the request to authenticate the information as received from client 61 0. In step 740, if the digital signature is not valid, in step 742, KMS 650 ignores, rejects, or otherwise discards the request.

In step 740, if the digital signature is valid, in step 744, KMS 650 decrypts the request. In step 746, KMS 650 performs one or more key management functions indicated by the request. For example, key management server may generate any key, destroy a key, obtain a key, update a key, update metadata associated with the key, generate a label for a key, and the like.

In step 748, KMS 650 generates a response indicative of performance of the one or more key management functions. In step 750, KMS 650 encrypts and digitally signs the response indicating the results of the key management functions. In step 752, KMS 650 delivers encrypted and digitally signed response indicating the results of the key management functions to local e-mail server 640 addressed to client 610. For example, KMS 650 may address the response to an e-mail address associated with a user of client 610.

In step 754, local e-mail server 640 forwards the response to remote e-mail server 620 for delivery to client 610. In step 756, remote e-mail server 620 stores the response in a mailbox for client 610. For example, remote e-mail server 620 may interface with an Exchange, POP3, IMAP, or Web-mail server.

In step 758, client 610 retrieves the response delivered to remote e-mail server 620. For example, the user of client 610 may manually retrieve the response from remote e-mail server 620. In another example, a computer process executing on client 610 may periodically polls remote e-mail server 620 to determine whether the response has arrived. In step 760, client 610 processes the response to obtain the results of the one or more key management functions. For example, client 610 may obtain a key to decrypt a digital object. Message sequence chart 700 ends in FIG. 7C at step 760.

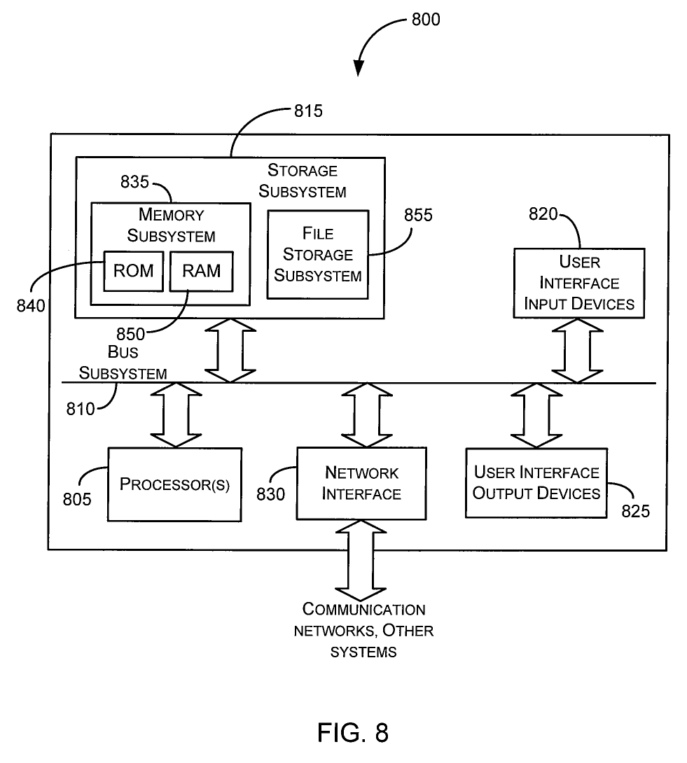

FIG. 8 is a simplified block diagram of a computer system 800 that may be used to practice embodiments of the present invention. As shown in FIG. 8, computer system 800 includes a processor 802 that communicates with a number of peripheral devices via a bus subsystem 804. These peripheral devices may include a storage subsystem 806, comprising a memory subsystem 808 and a file storage subsystem 810, user interface input devices 812, user interface output devices 814, and a network interface subsystem 816.

Bus subsystem 804 provides a mechanism for letting the various components and subsystems of computer system 800 communicate with each other as intended. Although bus subsystem 804 is shown schematically as a single bus, alternative embodiments of the bus subsystem may utilize multiple buses.

Network interface subsystem 816 provides an interface to other computer systems, and networks, and devices. Network interface subsystem 816 serves as an interface for receiving data from and transmitting data to other systems from computer system 800.

User interface input devices 812 may include a keyboard, pointing devices such as a mouse, trackball, touchpad, or graphics tablet, a scanner, a barcode scanner, a touchscreen incorporated into the display, audio input devices such as voice recognition systems, microphones, and other types of input devices. In general, use of the term “input device” is intended to include all possible types of devices and mechanisms for inputting information to computer system 800.

User interface output devices 814 may include a display subsystem, a printer, a fax machine, or non-visual displays such as audio output devices, etc. The display subsystem may be a cathode ray tube (CRT), a flat-panel device such as a liquid crystal display (LCD), or a projection device. In general, use of the term “output device” is intended to include all possible types of devices and mechanisms for outputting information from computer system 800.

Storage subsystem 806 may be configured to store the basic programming and data constructs that provide the functionality of the present invention. Software (code modules or instructions) that provides the functionality of the present invention may be stored in storage subsystem 806. These software modules or instructions may be executed by processor(s) 802. Storage subsystem 806 may also provide a repository for storing data used in accordance with the present invention. Storage subsystem 806 may comprise memory subsystem 808 and file/disk storage subsystem 810.

Memory subsystem 808 may include a number of memories including a main random access memory (RAM) 818 for storage of instructions and data during program execution and a read only memory (ROM) 820 in which fixed instructions are stored. File storage subsystem 810 provides persistent (non-volatile) storage for program and data files, and may include a hard disk drive, a floppy disk drive along with associated removable media, a Compact Disk Read Only Memory (CD-ROM) drive, a DVD, an optical drive, removable media cartridges, and other like storage media.

Computer system 800 can be of various types including a personal computer, a portable computer, a workstation, a network computer, a mainframe, a kiosk, or any other data processing system. Due to the ever-changing nature of computers and networks, the description of computer system 800 depicted in FIG. 8 is intended only as a specific example for purposes of illustrating the preferred embodiment of the computer system. Many other configurations having more or fewer components than the system depicted in FIG. 8 are possible.

Although specific embodiments of the invention have been described, various modifications, alterations, alternative constructions, and equivalents are also encompassed within the scope of the invention. The described invention is not restricted to operation within certain specific data processing environments, but is free to operate within a plurality of data processing environments. Additionally, although the present invention has been described using a particular series of transactions and steps, it should be apparent to those skilled in the art that the scope of the present invention is not limited to the described series of transactions and steps.

Further, while the present invention has been described using a particular combination of hardware and software, it should be recognized that other combinations of hardware and software are also within the scope of the present invention. The present invention may be implemented only in hardware, or only in software, or using combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claims.

What is claimed is:

1. A method for providing controlled key management, the method comprising:
generating a request indicative of a key management function;
receiving the request at the first of a number of intermediate parties capable of relaying the request toward a key management server;
performing the key management function subsequent to receiving the request from the last of the intermediate parties which is authorized to provide the request to the key management server; and
generating a response to the request.

2. The method of claim 1 wherein receiving the request at the first of a number of intermediate parties capable of relaying the request toward a key management server comprises receiving the request at the first of the number of intermediate parties using a store and forward protocol.

3. The method of claim 1 wherein receiving the request at the first of a number of intermediate parties capable of relaying the request toward a key management server comprises receiving the request at an e-mail server.

4. The method of claim 1 wherein the number of intermediate parties is one such that receiving the request at the first of a number of intermediate parties capable of relaying the request toward a key management server comprises receiving the request at the last of the number of intermediate parties.

5. The method of claim 1 further comprising:
receiving the response to the request at the first of a number of intermediate parties capable of relaying the response to a client; and
wherein the last of the number of intermediate parties is configured to deliver the response to the client.

6. The method of claim 1 wherein the key management function comprises at least one of a create operation, a store operation, a retrieve operation, a find operation, a disable operation, a destroy operation, and a modify operation.

7. The method of claim 1 further comprising:
encrypting the request; and
digitally signing the request.

8. The method of claim 7 further comprising:
authenticating the request in response to the digital signature; and
decrypting the request based on a positive determination that the request is authentic.

9. The method of claim 1 further comprising:
encrypting the response; and
digitally signing the response.

10. The method of claim 9 further comprising:
authenticating the response in response to the digital signature; and
decrypting the response based on a positive determination that the request is authentic.

11. A computer program product stored on a computer readable medium for providing controlled key management, the computer program product comprising:
code for generating a request indicative of a key management function;
code for receiving the request at the first of a number of intermediate parties capable of relaying the request toward a key management server;
code for performing the key management function subsequent to receiving the request from the last of the intermediate parties which is authorized to provide the request to the key management server; and
code for generating a response to the request.

12. The computer program product of claim 11 wherein the code for receiving the request at the first of a number of intermediate parties capable of relaying the request toward a key management server comprises code for receiving the request at the first of the number of intermediate parties using a store and forward protocol.

13. The computer program product of claim 1I1 wherein the code receiving the request at the first of a number of intermediate parties capable of relaying the request toward a key management server comprises code for receiving the request at an e-mail server.

14. The computer program product of claim 11 wherein the number of intermediate parties is one such that the code for receiving the request at the first of a number of intermediate parties capable of relaying the request toward a key management server comprises code for receiving the request at the last of the number of intermediate parties.

15. The computer program product of claim 11 further comprising:
code for receiving the response to the request at the first of a number of intermediate parties capable of relaying the response to a client; and
wherein the last of the number of intermediate parties is configured to deliver the response to the client.

16. The computer program product of claim 1I1 wherein the key management function comprises at least one of a create operation, a store operation, a retrieve operation, a find operation, a disable operation, a destroy operation, and a modify operation.

17. The computer program product of claim 11 further comprising:
code for encrypting the request; and
code for digitally signing the request.

18. The computer program product of claim 17 further comprising:
code for authenticating the request in response to the digital signature; and
code for decrypting the request based on a positive determination that the request is authentic.

19. The computer program product of claim 11 further comprising:
code for encrypting the response; and
code for digitally signing the response.

20. The method of claim 19 further comprising:
code for authenticating the response in response to the digital signature; and
code for decrypting the response based on a positive determination that the request is authentic.

21. A system for providing controlled key management, the system comprising:
a number of intermediate parties, where the first of the number of intermediate parties is configured to receive a request indicative of a key management function from a client, and where the last of the number of intermediate parties is authorized to provide the request to one or more key management servers; and
a key management server configured to:
receive the request from the last of the number of intermediate parties;
perform the key management function; and
generate a response to the request.

22. A system for secured key management, the system comprising:
a key management server; and
a first server communicatively positioned between the key management server and a client and configured to:
receive a request addressed to the key management server from the client, the request indicative of a key management function;
deliver the request to the key management server if the first server is authorized to deliver a request from a client to the key management server, and relay the request to a second server communicatively positioned between the key management server and the client if the first server is not configured to access the key management server.

23. The system of claim 22 wherein the first server is further configured to receive the request using a store and forward protocol.

24. The system of claim 22 wherein the first server comprises an e-mail server.

25. The system of claim 22 wherein the first server is further configured to:
receive a response to the request addressed to the client;
deliver the response to the client if the first server is configured to access the client; and
relay the response to a third server if the first server is not configured to access the client.

26. A system for providing controlled key management, the system comprising:
a processor; and
a memory coupled to the processor, the memory configured to store a plurality of code modules which when executed by the processor cause the processor to:
receive a request addressed to a key management server from a client, the request indicative of a key management function;
deliver the request to the key management server based on receiving authorization to deliver requests from clients to the key management server; and
relay the request to a first host communicatively positioned between the key management server and the client if not permitted to access the key management server.

27. The system of claim 26 wherein the processor is configured to receive the request using a store and forward protocol.

28. The system of claim 26 wherein the processor is configured to receive the request using a simple mail transfer protocol.

29. The system of claim 26 wherein the processor is configured to:
receive a response to the request addressed to the client;
deliver the response to the client if capable of accessing the client; and
relay the response to a second host communicatively positioned between the key management server and the client if not capable of accessing the client.
